(19) United States
(12) Patent Application Publication
(10) Pub. No.: US 2001/0056345 A1
(43) Pub. Date: Dec. 27, 2001

(54) Method and system for speech recognition of the alphabet

(76) Inventor: David Guedalia, Beit Shemesh (IL)

Correspondence Address: ABELMAN FRAYNE & SCHWAB, Attorneys at Law, 150 East 42nd Street, New York, NY, 10017, US

(21) Appl. No.: 09/840,521

(22) Filed: Apr. 23, 2001

Related U.S. Application Data
(60) Provisional application No. 60/199,741, filed on Apr. 25, 2000.

(51) Int. Cl. G10L 15/06

(52) U.S. Cl. 704/243

(57) ABSTRACT

A method for speech recognition of an alphabet including receiving an audio input including at least one letter of an alphabet and at least one word, recognizing the letter of an alphabet and the word in the audio input; and mapping the word to the letter.

### REFERENCE TO RELATED APPLICATIONS

This application claims priority from co-pending U.S. Provisional Application Serial No. 60/199,741 entitled Method and System for Speech Recognition of the Alphabet, filed Apr. 25, 2001.

### FIELD OF THE INVENTION

The present invention relates to Speech Recognition of the Alphabet.

### BACKGROUND OF THE INVENTION

Speech recognition is becoming increasingly popular in telephone use, particularly due to the fact that it enables hands-free usage of the phone. Speech comes naturally to most people who do not have to learn new tasks in order to give speech commands. In general, speech recognition involves the ability to match a voice pattern against a provided or acquired vocabulary. Usually, a limited vocabulary is provided with a product and the user can record additional words. More sophisticated software has the ability to accept natural speech, i.e. speech as persons usually speak rather than carefully-spoken speech.

Speech recognition systems typically fall into two categories, namely speaker-dependent systems and speaker-independent systems. Speaker dependent systems need to recognize speech spoken by predetermined individual voices and thus require users to articulate speech samples into the system. Speaker-independent systems do not require individual speech samples and are typically capable of recognizing a finite number of words and digits, such as credit card details.

Voice recognition applications can typically be categorized into three different types. Firstly there are Command applications, which are capable of recognizing a few words and can identify a correct word through a process of elimination. This type of application is the least demanding on a computer. Discrete voice recognition systems can be used for dictation, but require a user to leave a pause between each spoken word. Continuous voice recognition can understand natural speech without the need for pauses. This type of application is the most demanding on a processor.

Successful speech recognition has the potential of automating basic services. One such service is telephone directory assistance. U.S. Pat. No. 5,638,425 entitled “Automated directory assistance system using word recognition and phoneme processing method” presents a system, which provides one such service. Another approach to speaker independent voice recognition of the alphabet is presented in U.S. Pat. No. 5,621,857 entitled “Method and system for identifying and recognizing speech.”

The aforementioned systems still have difficulty in recognizing individual letters of the alphabet. For example, U.S. Pat. No. 5,638,425 states as follows: “The system also includes provision for DTMF keyboard input in aid of the spelling procedure.” From which one can infer that the user may be in need of aid.

One of the difficulties involved in recognition of the spoken alphabet is that many letters sound identical, especially when spoken via a telephone or other such low quality audio device. For example, the letter ‘E’ and the letters ‘B’, ‘C’, ‘D’ and ‘V’ all contain an ‘ee’ sound and are often confused when heard over the telephone.

There are various approaches to addressing the problem of acoustic confusability. One can define certain rules relating to word sequences or define contexts or develop a. personalized dictionary, containing words with confusable letters.

U.S. Pat. No. 6,182,039 entitled “Method and apparatus using probabilistic language model based on confusable sets for speech recognition” takes a different approach to the problem, by embedding knowledge of acoustic confusability directly into a recognizer. The invention proposes a core speech recognition solution to the problem of acoustic confusability.

### SUMMARY OF THE INVENTION

The present invention seeks to provide a system and a method for speech recognition of letters of an alphabet.

There is thus provided in accordance with a preferred embodiment of the present invention, a method for speech recognition of an alphabet including receiving an audio input including at least one letter of an alphabet and at least one word, recognizing the at least one letter of an alphabet and the at least one word in the audio input and mapping the at least one word to the at least one letter.

There is additionally provided in accordance with a preferred embodiment of the present invention a method for speech recognition of an alphabet including receiving an audio input including at least one target word made up of a plurality of letters in an alphabet and at least one auxiliary word corresponding to each of the plurality of letters, recognizing the plurality of auxiliary words in the audio input, mapping each of the plurality of auxiliary words to a corresponding one of the plurality of letters and composing the target word from the plurality of letters.

There is additionally provided in accordance with a preferred embodiment of the present invention a system for speech recognition of an alphabet including a receiver, receiving an audio input including at least one letter of an alphabet and at least one word, a recognizer, recognizing the at least one letter of an alphabet and the at least one word in the audio input and a mapper, mapping the at least one word to the at least one letter.

Further in accordance with a preferred embodiment of the present invention there is provided a system for speech recognition of an alphabet including a receiver, receiving an audio input including at least one target word made up of a plurality of letters in an alphabet and at least one auxiliary word corresponding to each of the plurality of letters, a recognizer, recognizing the plurality of auxiliary words in the audio input, a mapper, mapping each of the plurality of auxiliary words to a corresponding one of the plurality of letters and a target word generator composing the target word from the plurality of letters.

According to a preferred embodiment of the present invention, the audio input is received via a telephone.

Preferably, the audio input is received via a microphone.

In accordance with a preferred embodiment of the present invention, the at least one word is selected from a set of names such as names of persons or fruits.

Preferably the system and methodology also provide an audio feedback of letters of an alphabet to which recognized words are mapped.

In accordance with a preferred embodiment of the present invention, the system and methodology also combines a plurality of the at least one letters into a target word.

Additionally in accordance with a preferred embodiment of the present invention, the system and methodology also annunciates the target word to a user. In one embodiment of the present invention, this annunciation takes place prior to mapping of all of the letters making up the target word.

Preferably, the mapping includes matching the first letter of the at least one word to the at least one letter.

### BRIEF DESCRIPTION OF THE DRAWINGS

The present invention will be more fully understood and appreciated from the following detailed description, taken in conjunction with the following drawing in which:

FIG. 1 is a functional block diagram of a system for speech recognition of letters of an alphabet;

FIG. 2 is a simplified flow chart, illustrating a process useful in speech recognition of an alphabet in a system of the type shown in FIG. 1.

### DETAILED DESCRIPTION OF A PREFERRED EMBODIMENT

The present invention proposes a method and system for automated speech recognition of letters of an alphabet. The system is designed to map easily recognized words in common usage, such as names, to letters. Mapping such words to letters actively improves the statistical differences in the features of speech extracted by the speech recognition engine.

In one embodiment of the present invention, a user wishing to spell a target word speaks a set of words, each corresponding to a different letter of the target word. For example, should a user wish to spell out the name ‘KELLY’ the user might say the following set of words: Kangaroo, Elephant, Llama, Llama, Yak. The system would respond with the letters: ‘K’, ‘E’, ‘L’, ‘L’, ‘Y’.

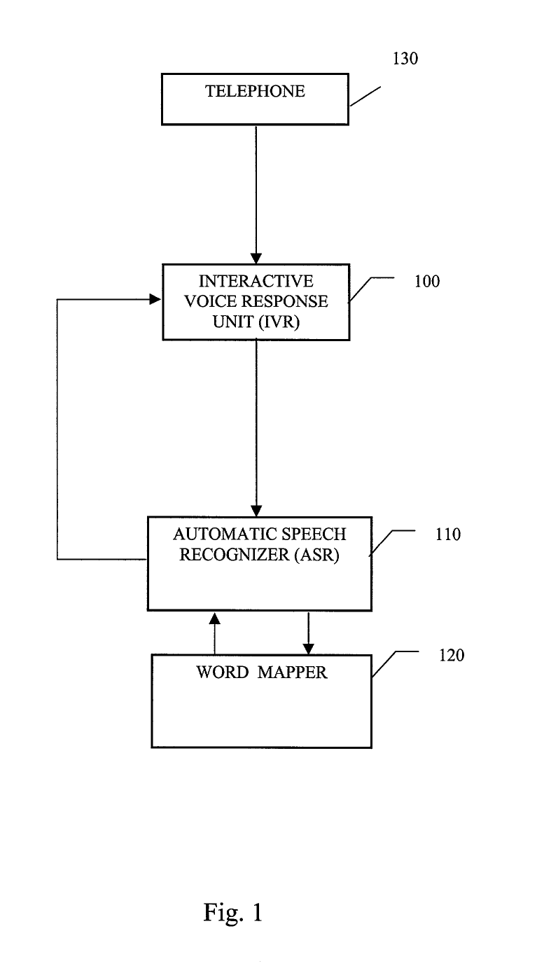

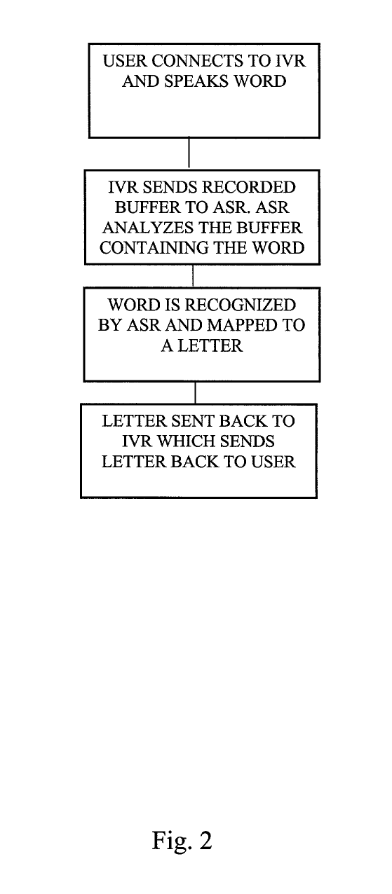

Reference is now made to FIGS. 1 and 2, which illustrate the structure and operation of a preferred embodiment of the present invention which recognizes a target word, made up of letters of an alphabet, each of which corresponds to an auxiliary word. The auxiliary word is preferably an easily recognized word which is in common usage, such as the name of a person or an object.

A user preferably contacts a Interactive Voice Response Unit (IVR) computer 100 and speaks a first auxiliary word. The IVR listens to the first auxiliary word and supplies it to an Automatic Speech Recognition Unit (ASR) 110. The ASR analyzes the word and recognizes the spoken word. An alphabet mapping module 120 maps the auxiliary word thus recognized to a letter of an alphabet.

The foregoing functionality is repeated for each spoken auxiliary word, preferably in the order that the auxiliary words are spoken.

As an alternative, the target word may also be spoken.

Optionally, as each letter is mapped, that letter may be spoken to the user by the IVR 100.

In a preferred embodiment of the present invention, the employs a POTS telephone 130 for interaction with the system functionality. The IVR 100 answers a telephone call from the telephone 130 and typically recommends to the user the use of a word group/vocabulary, such as ‘Names of People.’ The system then conducts a session with the user in which the user speaks, an auxiliary word, here typically the name of a person, that begins with the first letter of the target word. The system recognizes the auxiliary word and typically responds with the first letter of the target word.

Thus a user might say the auxiliary word ‘Tom’ and the system would respond with the letter ‘T’.

The user then speaks the name of a person that begins with the second letter of the target word and the system recognizes that name and identifies the second letter of the target word. The functionality continues in a similar manner until all of the letters of the target word have thus been identified.

Alternatively, even before all of the letters of the target word have been identified, the system may identify the target word and may annunciate it to the user via the IVR .

It will be appreciated by persons skilled in the art that the present invention is not limited by what has been particularly shown and described hereinabove. Rather the present invention includes combinations and subcombinations of the various features described hereinabove as well as modifications and extensions thereof which would occur to a person skilled in the art and which do not fall within the prior art.

1. A method for speech recognition of an alphabet comprising:
receiving an audio input including at least one letter of an alphabet and at least one word;
recognizing said at least one letter of an alphabet and said at least one word in said audio input; and
mapping said at least one word to said at least one letter.

2. A method according to claim 1 and wherein said audio input is received via a telephone.

3. A method according to claim 1 and wherein said audio input is received via a microphone.

4. A method according to claim 1 and wherein said at least one word is selected from a set of names.

5. A method according to claim 1 and wherein said at least one word is selected from a set of names of fruits.

6. A method according to claim 1 and also comprising providing an audio feedback of letters of an alphabet to which recognized words are mapped.

7. A method according to claim 1 and also comprising combining a plurality of said at least one letters into a target word.

8. A method according to claim 7 and also comprising annunciating said target word to a user.

9. A method according to claim 8 and wherein said annunciating includes annunciating said target word prior to mapping of all of the letters making up said target word.

10. A method according to claim 1 and wherein said mapping comprises matching the first letter of said at least one word to said at least one letter.

11. A method for speech recognition of an alphabet comprising:
receiving an audio input including at least one target word made up of a plurality of letters in an alphabet and at least one auxiliary word corresponding to each of said plurality of letters;
recognizing said plurality of auxiliary words in said audio input;
mapping each of said plurality of auxiliary words to a corresponding one of said plurality of letters; and
composing said target word from said plurality of letters.

12. A method according to claim 11 and wherein said audio input is received via a telephone.

13. A method according to claim 11 and wherein said audio input is received via a microphone.

14. A method according to claim 11 and wherein said plurality of auxiliary words is selected from a set of names.

15. A method according to claim 11 and wherein said plurality of auxiliary words is selected from a set of names of fruits.

16. A method according to claim 11 and also comprising providing an audio feedback of letters of said alphabet to which recognized auxiliary words are mapped.

17. A method according to claim 11 and wherein said composing comprises combining said plurality of said at least one letters in the order recognized into said target word.

18. A method according to claim 17 and also comprising annunciating said target word to a user.

19. A method according to claim 18 and wherein said annunciating includes annunciating said target word prior to mapping of all of the letters making up said target word.

20. A method according to claim 11 and wherein said mapping comprises matching the first letter of each of said plurality of auxiliary words to said at least one letter.

21. A system for speech recognition of an alphabet comprising:
a receiver, receiving an audio input including at least one letter of an alphabet and at least one word;
a recognizer, recognizing said at least one letter of an alphabet and said at least one word in said audio input; and
a mapper, mapping said at least one word to said at least one letter.

22. A system according to claim 21 and wherein said audio input is received via a telephone.

23. A system according to claim 21 and wherein said audio input is received via a microphone.

24. A system according to claim 21 and wherein said at least one word is selected from a set of names.

25. A system according to claim 21 and wherein said at least one word is selected from a set of names of fruits.

26. A system according to claim 21 and also comprising an audio output generator providing an audio feedback of letters of an alphabet to which recognized words are mapped.

27. A system according to claim 21 and also comprising a word generator combining a plurality of said at least one letters into a target word.

28. A system according to claim 27 and also comprising an annunciator, annunciating said target word to a user.

29. A system according to claim 28 and wherein said annunciator is operative to annunciate said target word prior to mapping of all of the letters making up said target word.

30. A system according to claim 21 and wherein said mapper is operative to match the first letter of said at least one word to said at least one letter.

31. A system for speech recognition of an alphabet comprising:
a receiver, receiving an audio input including at least one target word made up of a plurality of letters in an alphabet and at least one auxiliary word corresponding to each of said plurality of letters;
a recognizer, recognizing said plurality of auxiliary words in said audio input;
a mapper, mapping each of said plurality of auxiliary words to a corresponding one of said plurality of letters; and
a target word generator composing said target word from said plurality of letters.

32. A system according to claim 31 and wherein said audio input is received via a telephone.

33. A system according to claim 31 and wherein said audio input is received via a microphone.

34. A system according to claim 31 and wherein said plurality of auxiliary words is selected from a set of names.

35. A system according to claim 31 and wherein said plurality of auxiliary words is selected from a set of names of fruits.

36. A system according to claim 31 and also comprising an audio feedback generator, providing an audio feedback of letters of said alphabet to which recognized auxiliary words are mapped.

37. A system according to claim 31 and wherein said target word generator is operative to combine said plurality of said at least one letters in the order recognized into said target word.

38. A system according to claim 37 and also comprising an annunciator, annunciating said target word to a user.

39. A system according to claim 38 and wherein said annunciator is operative to annuniciate said target word prior to mapping of all of the letters making up said target word.

40. A system according to claim 31 and wherein said mapper is operative to match the first letter of each of said plurality of auxiliary words to said at least one letter.
